(19) United States
(12) Patent Application Publication
(10) Pub. No.: US 2019/0212830 A1
(43) Pub. Date: Jul. 11, 2019

(54) CAMERA MODULE AND MOBILE DEVICE HAVING THE SAME

(71) Applicants: BOE TECHNOLOGY GROUP CO., LTD., Beijing (CN); Chengdu BOE Optoelectronics Technology Co., Ltd., Chengdu (CN)

(72) Inventors: Yuanjie Xu, Beijing (CN); Shan Gao, Beijing (CN); Pengcheng Zang, Beijing (CN); Ting Li, Beijing (CN); Zhonglin Cao, Beijing (CN); Jing He, Beijing (CN); Wei Guo, Beijing (CN); Shiqi Chen, Beijing (CN)

(21) Appl. No.: 16/193,771

(22) Filed: Nov. 16, 2018

(30) Foreign Application Priority Data
Jan. 10, 2018 (CN) 201810023073.0

(51) Int. Cl. G06F 3/02; G06F 3/0362; H04N 5/225

(52) U.S. Cl. CPC G06F 3/02; H04M 1/0202; H04N 5/2254; G06F 3/0362

(57) ABSTRACT

The present disclosure provides a camera module and a mobile device having the same. The camera module includes a main lens disposed to a back surface of the mobile device and at least one function key. The at least one function key is located on the back surface of the mobile device and adjacent to the main lens, and connected to a control system of the mobile device. The at least one function key corresponds to at least one control command of the control system when triggered.

### CROSS-REFERENCE TO RELATED APPLICATIONS

The present application is based on and claims priority to Chinese Application No. 201810023073.0, filed on Jan. 10, 2018, the entire contents thereof are incorporated herein by reference.

### TECHNICAL FIELD

The present disclosure relates to the field technology of mobile device, and in particular, to a camera module and a mobile device having the same.

### BACKGROUND

Referring to FIGS. 1a and 1b, FIG. 1a shows a front view of an existing mobile device and FIG. 1b shows a rear view of the existing mobile device. As shown in FIG. 1a and FIG. 1b, a home button 102 of the existing mobile device is usually disposed right below a front surface of the mobile device (i.e., a side on which a screen 101 is provided), and a volume button 103 and a power button 104 are respectively disposed at left and right sides of the mobile device, and each function key is triggered by pressing. In the above existing design, both the home button 102 and the screen 101 are disposed to the front surface of the mobile device, so that not only the device space is occupied and the screen ratio is reduced, but also the home key is dispersedly distributed with other function keys such as the volume key 103 and the power button 104 disposed to both sides of the mobile device, thus affecting the thin design and leading to inconvenient for the user to operate.

### SUMMARY

In accordance with an aspect of the present disclosure, there is provided a camera module, which is mounted to a mobile device. The camera module includes a main lens disposed to a back surface of the mobile device. The camera module further includes at least one function key. The at least one function key is disposed to the back surface of the mobile device and adjacent to the main lens, and connected to a control system of the mobile device. The at least one function key corresponds to at least one control command of the control system when the at least one function key is triggered.

According to one of the arrangements of the present disclosure, the camera module includes a plurality of function keys, and the plurality of function keys are spaced around the periphery of the main lens.

According to one of the arrangements of the present disclosure, the plurality of function keys are evenly distributed.

According to one of the arrangements of the present disclosure, the camera module includes four function keys, and when the four function keys are triggered, the corresponding control commands are respectively power-on/off, home page confirmation, volume & brightness increase, volume & brightness reduction.

According to one of the arrangements of the present disclosure, four function keys are respectively an upper function key, a lower function key, a left function key and a right function key disposed adjacent to upper, lower, left and right directions of the main lens; wherein control commands to which the upper function key, the lower function key, the left function key and the right function key correspond when triggered are respectively power-on/off, home page confirmation, volume & brightness increase, volume & brightness reduction.

According to one of the arrangements of the present disclosure, the camera module includes a plurality of function keys, and the plurality of function keys present an integral annular structure surrounding a periphery of the main lens.

According to one of the arrangements of the present disclosure, the plurality of function keys are evenly distributed, and different functional areas are distinguished by contacts at different positions inside the annular structure.

According to one of the arrangements of the present disclosure, the camera module includes four function keys, and when the four function keys are triggered, the corresponding control commands are respectively power-on/off, home page confirmation, volume & brightness increase, volume & brightness reduction.

According to one of the arrangements of the present disclosure, the camera module includes a function key, and the function key is in an annular structure surrounding the periphery of the main lens.

According to one of the arrangements of the present disclosure, a triggering mode of the function key is to trigger by circumferentially rotating along the main lens.

According to one arrangement of the present disclosure, when the function key is triggered, the corresponding control command of the control system includes at least two types, one of which type is triggered when the function key rotates clockwise, and the other of which type is triggered when the function key rotates counterclockwise.

According to one of the arrangements of the present disclosure, the function key is provided with a notch or is provided with a stripe.

According to one of the arrangements of the present disclosure, the function key is provided with a notch and is provided with a stripe.

According to one of the arrangements of the present disclosure, a triggering mode of each of the function keys is press triggering or rotation triggering.

According to one of the arrangements of the present disclosure, a triggering mode of each of the function keys is press triggering and rotation triggering.

In accordance with another aspect of the present disclosure, a mobile device is provided. The mobile device includes a body and a camera module mounted to the body. The camera module includes a main lens disposed to a back surface of the mobile device. The camera module includes at least one function key disposed to the back surface of the mobile device and adjacent to the main lens. The at least one function key is connected to a control system of the mobile device. The at least one function key corresponds to at least one control command of the control system when the at least one function key is triggered.

According to one of the arrangements of the present disclosure, the camera module includes a plurality of function keys, and the plurality of function keys are spaced around the periphery of the main lens.

According to one of the arrangements of the present disclosure, the camera module includes four function keys, and when the four function keys are trigged, the corresponding control commands are respectively power-on/off, home page confirmation, volume & brightness increase, volume & brightness reduction.

According to one of the arrangements of the present disclosure, the camera module includes a plurality of function keys, and the plurality of function keys present an integral annular structure surrounding the periphery of the main lens.

According to one of the arrangements of the present disclosure, the plurality of function keys are evenly distributed, and different functional areas are distinguished by contacts at different positions inside the annular structure.

### BRIEF DESCRIPTION OF THE DRAWINGS

The various objects, features and advantages of the present disclosure will become more apparent from the detailed description of the preferred arrangements of the present disclosure with reference to the accompanying drawings. The drawings are only illustrative of the present disclosure and are not necessarily to scale. In the drawings, like reference numbers generally refer to the same or similar components. In the drawings:

FIG. 1a is a front view of an existing mobile device;

FIG. 1b is a rear view of the existing mobile device shown in FIG. 1a;

FIG. 2a is a rear view of a mobile device according to an exemplary arrangement;

FIG. 2b is a front view of the mobile device shown in FIG. 2a;

FIG. 2c is a side view of the mobile device shown in FIG. 2a;

FIG. 3 is a rear view of a mobile device according to another exemplary arrangement.

### DETAILED DESCRIPTION

Exemplary arrangements embodying the features and advantages of the present disclosure will be described in detail in the following description. It should be understood that the present disclosure is capable of various modifications in the various arrangements without departing from the scope of the present disclosure, and the description and drawings thereof are intended to illustrate only and not limit the present disclosure.

The following description of the various exemplary arrangements of the present disclosure refers to the drawings, which constitute part of the present disclosure and show different exemplary structures, systems and blocks implementing various aspects of the present disclosure by way of example. It should be understood that other specific aspects of components, structures, exemplary devices, systems and steps can be used, and structural and functional modifications can be made without departing from the scope of the present disclosure. Moreover, although the terms “front,” “back,” “peripheral,” “side” or the like may be used in this specification to describe various exemplary features and elements of the present disclosure, these terms are used herein only for convenience, for example, the direction according to the example shown in the drawings. Nothing in this specification should be construed as requiring a specific three dimensional orientation of the structure to fall within the scope of the disclosure.

### First Embodiment of Camera Module

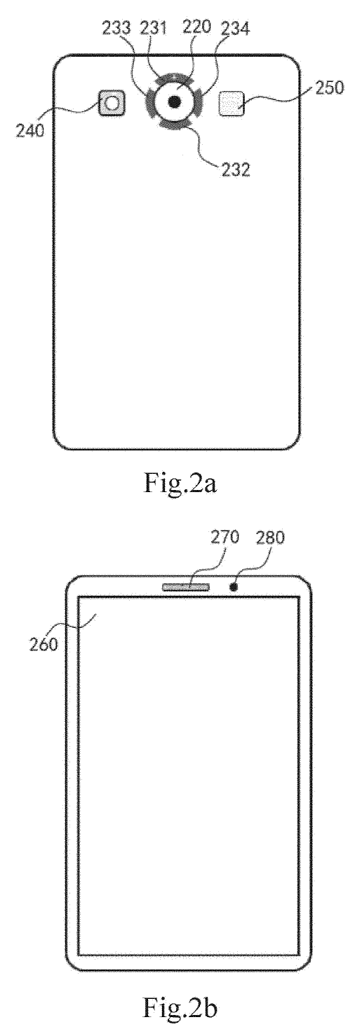

Referring to FIG. 2a, a rear view of the camera module, which is mounted to a mobile device, provided by the present disclosure is representatively shown. In the exemplary arrangement, the camera module provided by the present disclosure is described as an example to be applied in a smartphone or a tablet. Those skilled in the art will readily appreciate that many variations, additions, substitutions, deletions or other changes are made to the specific arrangements described below in order to apply the related designs of the present disclosure to other types of mobile devices, and these changes are still within the scope of the principle of the camera module provided by the present disclosure.

As shown in FIG. 2a, in the present arrangement, the camera module provided by the present disclosure is used to be mounted to a mobile device, such as a smart phone or a tablet. The camera module mainly includes a main lens 220 combined with four function keys, a front lens 280 and other related components. Combined with FIGS. 2b and 2c, FIG. 2b representatively illustrates a front view of a mobile device capable of embodying the principles of the present disclosure; and FIG. 2c representatively illustrates a side view of a mobile device capable of embodying the principles of the present disclosure. The structure, the mode of connection and the functional relationship of each main component of the camera module provided by the present disclosure will be described in detail below with reference to the above drawings.

As shown in FIG. 2a, in the present arrangement, the main lens 220 is disposed to a back surface of the body 210 of the mobile device, and four function keys are also disposed to the back surface of the mobile device and adjacent to the main lens 220. The four function keys are respectively disposed adjacent to upper, lower, left and right directions of the main lens 220, and may be respectively named as an upper function key 231, a lower function key 232, a left function key 233 and a right function key 234 in order to distinguish. In addition, the front lens 280 is disposed at a front surface of the body 210 of the mobile device to provide a self-timer function of the mobile device, and the related design of the front lens 280 may refer to the front lens 280 of the mobile device of the related art, which will not be described herein.

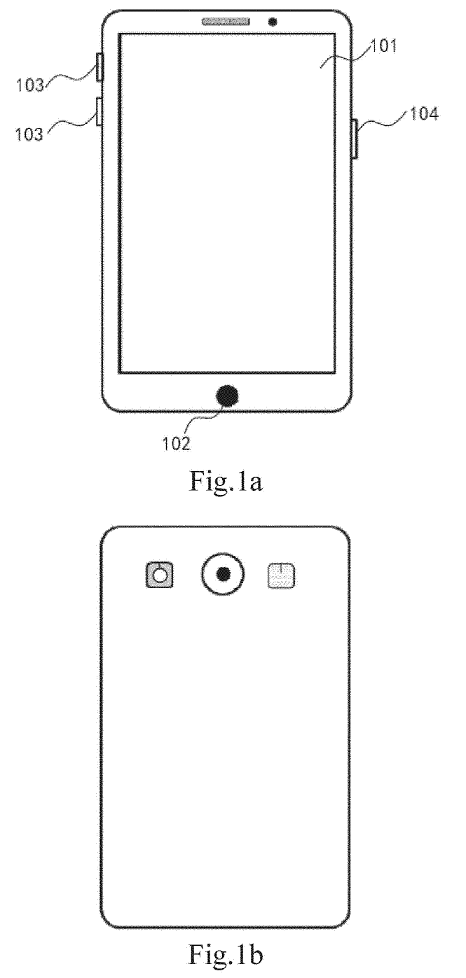

For example, based on the design of the existing mobile device having the home button 102, the volume button 103 and the power button 104 shown in FIG. 1a, the present arrangement implements operational functions of the above three buttons by using four function buttons. Specifically, the upper function key 231, the lower function key 232, the left function key 233 and the right function key 234 respectively cooperate with a control system of the mobile device, so that the control system gives a corresponding control command when the function key is triggered, and in the present arrangement, the control commands to which the upper function key 231, the lower function key 232, the left function key 233 and the right function key 234 correspond are respectively power-on/off, home page confirmation, volume & brightness increase, volume & brightness reduction. Accordingly, the present disclosure implements the control functions of the home button 102, the volume button 103, and the power button 104 of the existing mobile device by various function keys combined around the main lens 220, so that the mobile device has the advantages of large screen ratio, thin and light.

It should be noted that, in the present arrangement, the above design of the number, the distribution mode, and the corresponding control commands of function keys are only exemplary illustrations on the basis of control requirements on the function key of the existing device represented by the mobile device shown in FIG. 1a. In other arrangements, the function key may also be one or more function keys, and the distribution mode of the plurality of function keys with respect to the main lens 220 may also be flexibly adjusted. Moreover, even if the design of four function keys in the arrangement is taken as an example, these function keys may correspond to different control commands, for example, the upper function key 231 may correspond to any one of power-on/off, home page confirmation, volume & brightness increase, volume & brightness reduction. The lower function key 232, the left function key 233, and the right function key 234 may also correspond to any one of those.

In other arrangements, the design purpose of the present disclosure can be achieved in such a way that the camera module provided by the present disclosure combines with at least one function key at its main lens 220. For example, as shown in FIG. 2b, when the function key provides a function of home page confirmation, the home key 102 (shown in FIG. 1a) on the front surface of the existing mobile and located right below the screen 101 may be omitted to achieve at least an increase of the screen ratio of the mobile device. For another example, as shown in FIG. 2c, when the function key provides functions of power-on/off and volume & brightness adjustment, the volume key 103 and the power key 104 on the side of the existing mobile device may be omitted (as shown in FIG. 1a) to achieve at least the effect of lightening and thinning.

Further, as shown in FIG. 2a, in the present arrangement, the upper function key 231, the lower function key 232, the left function key 233, and the right function key 234 are distributed around the periphery of the main lens 220 in a spaced manner. In other arrangements, when there are a plurality of function keys, reference may be made to the design of surrounding the periphery of the main lens 220 in a spaced manner in the arrangement, or the design of the overall structure surrounding the main lens 220, i.e., a portion of the plurality of function keys exposed to the back surface of the body 210 presents an integral annular structure, and different functional areas are respectively distinguished by contacts at different positions inside the annular structure, so that the operator can press different functional areas of the annular structure to realize different control commands.

Further, as shown in FIG. 2a, in the present arrangement, the upper function key 231, the lower function key 232, the left function key 233, and the right function key 234 are evenly distributed around the periphery of the main lens 220. In other arrangements, the shape or size of different function keys may also be adjusted according to the usage frequency of control command to which each function key corresponds. For example, the size of the function key corresponding to the home page confirmation control command may be designed to be larger than the size of other function keys.

### Second Embodiment of Camera Module

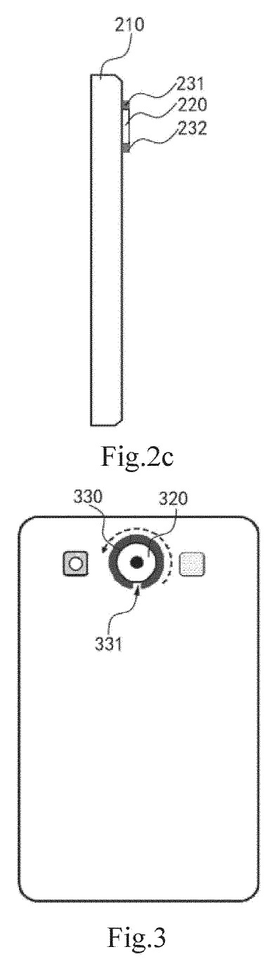

Referring to FIG. 3, a rear view of a camera module according to another arrangement of the present disclosure mounted to a mobile device is representatively shown. The camera module provided in this arrangement is substantially the same as the camera module provided in the previous arrangement, and main differences are as follows:

As shown in FIG. 3, in the arrangement, the camera module includes a function key 330, and the function key 330 presents an annular structure and surrounds a periphery of the main lens 320. The function key 330 is triggered by circumferentially rotating along the main lens 320. The control command to which the function key 330 corresponds may include at least two types, one of which type is triggered when the function key rotates clockwise, and the other of which type is triggered when the function key rotates counterclockwise. In addition, the function key 330 may be rotated in a stepwise manner (similar to an adjustment knob of some devices), or may be rotated with a return function, i.e., an elastic recovery mechanism returns to an original position after each rotation.

Further, as shown in FIG. 3, in the present arrangement, the function key 330 is provided with a notch 331 to facilitate rotational operation of the operator. In other arrangements, a stripe structure or the like may be disposed to the function key 330 to increase friction, i.e., the function key 330 is provided with a notch 331 or a stripe, or the function key 330 is provided with both a notch 331 and a stripe, but this arrangement will not limited thereto.

As described above, with respect to the different forms of design of the function keys, the triggering mode of each function key may be press triggering, rotation triggering or a combination of these two triggering modes. Moreover, triggering modes of the plurality of function keys may not be exactly the same. For example, in the first arrangement of the camera module, the function key may use a triggering mode of press triggering, or a triggering mode of a rotation triggering, or a combination of a press triggering and a rotation triggering, and the same function key of the combination of a press triggering and a rotation triggering may correspond to different control commands according to different operation modes. For another example, in the second arrangement of the camera module, the press triggering may be simultaneously applied to the function key having the annular structure to correspond to control commands different from the rotation triggering.

It should be noted herein that the camera modules shown in the drawings and described in this specification are only a few examples of many types of camera modules that can employ the principles of the present disclosure. It should be clearly understood that the principles of the present disclosure are not limited to any detail of the camera module or any component of the camera module shown in the drawings or described in this specification.

### First Embodiment of Mobile Device

Referring to FIG. 2a, a rear view of the mobile device provided by the present disclosure is representatively shown. In this exemplary arrangement, the mobile device provided by the present disclosure is described by taking a smartphone or a tablet as an example. It will be readily understood by those skilled in the art that various modifications, additions, substitutions, deletions, or other changes are made to the specific arrangements described below in order to apply the related designs of the present disclosure to other types of mobile devices and these changes are still within the scope of the principles of the mobile device provided by the present disclosure.

As shown in FIG. 2a to FIG. 2c, in the present arrangement, the mobile device provided by the present disclosure mainly includes a body 210 and a camera module mounted to the body 210. A screen 260 and an earpiece 270 are disposed to a front surface of the body 210, and a flash 240 and an audio 250 are disposed to a back surface. The camera module is the camera module of the present disclosure. Specifically, the camera module includes: a main lens disposed to the back surface of the mobile device; and at least one function key disposed to the back surface of the mobile device and adjacent to the a main lens, the function key being connected to a control system of the mobile device; wherein the function key corresponds to at least one control command of the control system when triggered. The arrangement is specifically embodied in the first arrangement of the camera module.

Referring to FIG. 3, a rear view of an arrangement of a mobile device provided by the present disclosure is representatively shown. The mobile device provided in this arrangement is substantially the same as the design of the camera module provided in the previous arrangement. The main difference is that the camera module in the present arrangement is specifically embodied in the second arrangement of the camera module.

It should be noted herein that the mobile devices shown in the drawings and described in this specification are only a few examples of the many types of mobile devices that can employ the principles of the present disclosure. It should be clearly understood that the principles of the present disclosure are not limited to any detail of the mobile device or any component of the mobile device shown in the drawings or described in the specification.

In summary, the camera module and the mobile device having the same provided by the present disclosure can be arranged to centralize function keys by integrating the function keys around the main lens of the camera module, and to separate them by the main lens in order to facilitate distinguishing. With the above design, the present disclosure is advantageous for a larger screen ratio when the function keys on the front surface of the mobile device are integrated to the main lens compared to the existing mobile device; it is advantageous for a thin and light device when the function keys on the side of the mobile device are integrated to the main lens. At the same time, the design of the present disclosure can make the user's operation more convenient and obtain a better user experience. Additionally, the present disclosure further enhances the integrity and aesthetics of the screen of the mobile device.

Exemplary arrangements of the camera module and the mobile device having the same provided by the present disclosure are described and/or illustrated in detail above. However, arrangements of the present disclosure are not limited to the specific arrangements described herein, but rather, the components and/or blocks of each arrangement can be used independently and separately from the other components and/or blocks described herein. Each component and/or each block of an arrangement may also be used in combination with other components and/or blocks of other arrangements. When introducing elements/components/etc. described and/or illustrated herein, the terms such as “a”, “an”, “the” and “said” are used to indicate the presence of one or more elements/components. The terms “comprise”, “include”, “have”, “contain” and their variants are used to be open-type and are meant to include additional elements/components, etc., in addition to the listed elements/components/etc.

While the camera module and the mobile device having the same of the present disclosure have been described in terms of various specific arrangements, those skilled in the art will recognize that the implementation of the present disclosure can be modified within the spirit and scope of the claims.

What is claimed is:

1. A camera module mounted to a mobile device, the camera module comprising:
a main lens disposed to a back surface of the mobile device;
at least one function key disposed to the back surface of the mobile device and adjacent to the main lens, the function key being connected to a control system of the mobile device;
wherein the function key corresponds to at least one control command of the control system when the function key is triggered.

2. The camera module according to claim 1, wherein the camera module comprises a plurality of function keys, and the plurality of function keys are spaced around a periphery of the main lens.

3. The camera module according to claim 2, wherein the plurality of function keys are evenly distributed.

4. The camera module according to claim 2, wherein the camera module comprises four function keys, and when the four function keys are triggered, corresponding control commands are respectively power-on/off, home page confirmation, volume & brightness increase, volume & brightness reduction.

5. The camera module according to claim 4, wherein the four function keys are respectively an upper function key, a lower function key, a left function key and a right function key disposed adjacent to upper, lower, left and right directions of the main lens, and wherein the control commands to which the upper function key, the lower function key, the left function key and the right function key, when triggered, correspond to respectively power-on/off, home page confirmation, volume & brightness increase, volume & brightness reduction.

6. The camera module according to claim 1, wherein the camera module comprises a plurality of function keys, and the plurality of function keys present an integral annular structure surrounding a periphery of the main lens.

7. The camera module according to claim 6, wherein the plurality of function keys are evenly distributed, and different functional areas are distinguished by contacts at different positions inside the annular structure.

8. The camera module according to claim 7, wherein the camera module comprises four function keys, and when the four function keys are triggered, corresponding control commands are respectively power-on/off, home page confirmation, volume & brightness increase, volume & brightness reduction.

9. The camera module according to claim 1, wherein the camera module comprises a function key, and the function key is in an annular structure surrounding a periphery of the main lens.

10. The camera module according to claim 9, wherein a triggering mode of the at least one function key is to trigger by circumferentially rotating along the main lens.

11. The camera module according to claim 9, wherein when the at least one function key is triggered, the at least one control command of the control system comprises at least two types, one of which type is triggered when the at least one function key rotates clockwise, and the other of which type is triggered when the at least one function key rotates counterclockwise.

12. The camera module according to claim 9, wherein the at least one function key is provided with a notch or is provided with a stripe.

13. The camera module according to claim 9, wherein the at least one function key is provided with a notch and is provided with a stripe.

14. The camera module according to claim 1, wherein a triggering mode of the at least one function key is press triggering or rotation triggering.

15. The camera module according to claim 1, wherein a triggering mode of the at least one function key is press triggering and rotation triggering.

16. A mobile device, comprising: a body and a camera module mounted to the body, wherein the camera module comprises: a main lens disposed to a back surface of the mobile device;
at least one function key disposed to the back surface of the mobile device and adjacent to the main lens, the at least one function key being connected to a control system of the mobile device;
wherein the at least one function key corresponds to at least one control command of the control system when the at least one function key is triggered.

17. The mobile device according to claim 16, wherein the camera module comprises a plurality of function keys, and the plurality of function keys are spaced around the periphery of the main lens.

18. The mobile device according to claim 17, wherein the camera module comprises four function keys, and when the four function keys are trigged, the corresponding control commands are respectively power-on/off, home page confirmation, volume & brightness increase, volume & brightness reduction.

19. The mobile device according to claim 16, wherein the camera module comprises a plurality of function keys, and the plurality of function keys present an integral annular structure surrounding the periphery of the main lens.

20. The mobile device according to claim 19, wherein the plurality of function keys are evenly distributed, and different functional areas are distinguished by contacts at different positions inside the annular structure.
